(19) United States
(12) Patent Application Publication
(10) Pub. No.: US 2007/0101781 A1
(43) Pub. Date: May 10, 2007

(54) Linear solenoid operated door locks with spring return, AC and DC types

(76) Inventor: Emery Galla, Broadview Hts, OH (US)

Correspondence Address: EMERY GALLA, 401 TOLLIS PKW #242, BROADVIEW HTS, OH, 44147, US

(21) Appl. No.: 11/186,996

(22) Filed: Oct. 20, 2005

(51) Int. Cl. E05B 47/00

(52) U.S. Cl. 70/257; 70/282

(57) ABSTRACT

This is a very simple keyless door lock, with switch box 120 volt and electrical wire connect 5, solenoid assembly to gather, and electrical signal box pocket size operate switch box, from outside of the door. Consist of 1, plunger, 2, spring 3, lockwasher 4, plainlockwasher, 5, solenoid, 6, doorframe block, 7, base plate. The hole assembly mounted on the door inside.

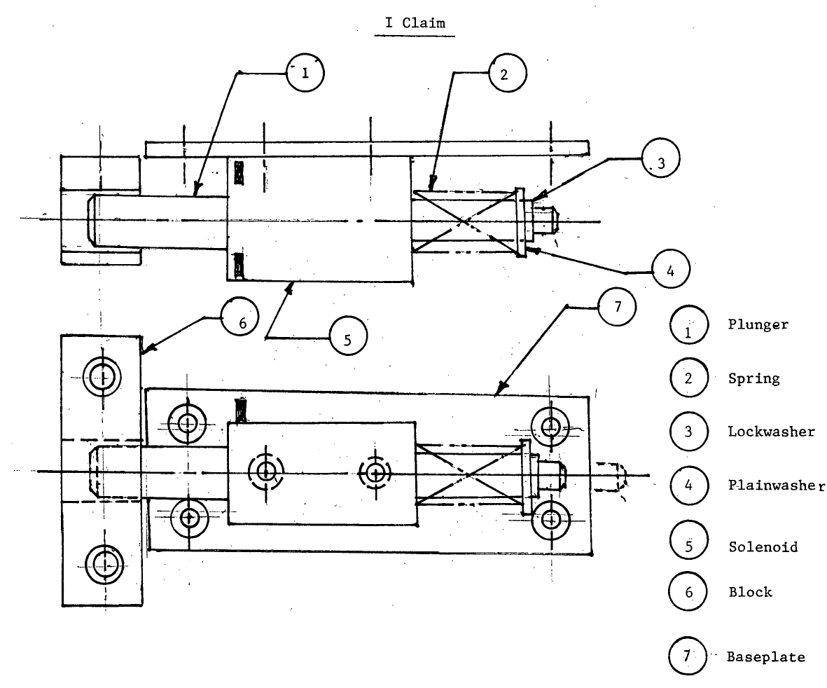

### CROSS-REFERENCE TO RELATED APPLICATIONS

This application claims the benefit of patent application No. 11/186,996, filed on Jul. 22, 2005 by present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to linear spring return solenoid door locks, specifically to such doors which are, assigned to certain people they responsible that area, no one can open that door. Also people worry about burglars of there homes, they need said lock.

1. Background of the Invention

Condominium doors, Apartment doors, Business, Factories, where safety is important like inventory listing and important documents are stored. Example: Very little electricity, and safety is 100% can not be open by others. Also safe no electricity goes to rest of the said locks, and no electric shocks. to worry of any kind. Can not lock out them self's, even if have powerfailer by electric company. The spring retracts the plunger. This said lock is very permanent nature. This is a new invention.

[symbol]

[symbol]

### BRIEF SUMMERY OF THE INVENTION

I have my problem with locks, someone can open my door and that someone breaking into my home, and I do not who is it. So I have to come up with something, I try to buy keyless lock, but nowhere I can found. So I had to come out with said lock. Called one of the company selling spring return solenoids, and they made one. It Works without keys so far works very good, because that person can not open my door, with keys. That made me to think to invent that device, to have a secret combination to that device, I can open only my self. I thought many other homeowners, condominium owners, apartment renters, business owners, can use that device. I try to buy it but no one made such device as I wanted. That made me to invent such device. That is why asking U.S. patent number for it. Because very use fool and new. Easily marketable because 100% burglar proof. Also does not have to worry about people lock them self out for. When has a power failure automatically the spring returns the plunger and the door open. Need no fear to be locked out from the house.

I claim

1. Drawing FIG. #3 show how it look like when it mounted on the door #12, switch box #13, pocket size remote control box #6, solenoid assembly & how it wired together. Hole system on that drawing FIG. #3, That is the hole claim.
